(19) United States
(12) Patent Application Publication
(10) Pub. No.: US 2010/0119829 A1
(43) Pub. Date: May 13, 2010

(54) METHOD FOR PRODUCING SURFACE-MODIFIED NANOPARTICULATE METAL OXIDES, METAL HYDROXIDES, AND/OR METAL OXIDE HYDROXIDES

(75) Inventors: Andrey Karpov, Mannheim (DE); Hartmut Hibst, Schriesheim (DE); Jing Hu, Stuttgart (DE); Bernd Bechtloff, Ludwigshafen (DE); Hartwig Voss, Frankenthal (DE); Kerstin Schierle-Arndt, Zwingenberg (DE); Valerie Andre, Ludwighafen (DE); Jens Rieger, Ludwigshafen (DE)

Correspondence Address: CONNOLLY BOVE LODGE & HUTZ, LLP, P O BOX 2207, WILMINGTON, DE, 19899, US

(73) Assignee: BASF SE, LUDWIGSHAFEN (DE)

(21) Appl. No.: 12/532,663

(22) PCT Filed: Mar. 18, 2008
(86) PCT No.: PCT/EP08/53218

§ 371 Date: Sep. 23, 2009

(30) Foreign Application Priority Data
Mar. 23, 2007 (EP) 07104724.5

(51) Int. Cl. B32B 5/00; C08K 3/22; C08K 9/04

(52) U.S. Cl. 428/407; 524/432; 523/205; 977/773

(57) ABSTRACT

The present invention relates to methods of producing surface-modified nanoparticulate particles at least of one metal oxide, metal hydroxide and/or metal oxide hydroxide, and aqueous suspensions of these particles. Furthermore, the invention relates to the surface-modified nanoparticulate particles, obtainable by these methods, at least of one metal oxide, metal hydroxide and/or metal oxide hydroxide and aqueous suspensions of these particles, and to their use for cosmetic sunscreen preparations, as stabilizer in plastics and as antimicrobial active ingredient.

The present invention relates to methods of producing surface-modified nanoparticulate particles at least of one metal oxide, metal hydroxide and/or metal oxide hydroxide, and aqueous suspensions of these particles. The invention further relates to the surface-modified nanoparticulate particles, obtainable by these methods, at least of one metal oxide, metal hydroxide and/or metal oxide hydroxide and aqueous suspensions of these particles, and to their use for cosmetic sunscreen preparations, as stabilizer in plastics and as antimicrobial active ingredient.

Metal oxides are used for diverse purposes, thus, for example, as white pigment, as catalyst, as constituent of antibacterial skin protection salves and as activator for the vulcanization of rubber. Finely divided zinc oxide or titanium dioxide as UV-absorbing pigments are found in cosmetic sunscreen compositions.

Nanoparticles is the term used to refer to particles in the nanometers order of magnitude. Being the size they are, they lie in the transition range between atomic or monomolecular systems and continuous macroscopic structures. Besides their mostly very large surface, nanoparticles are characterized by particular physical and chemical properties which differ significantly from those of larger particles. Thus, nanoparticles often have a lower melting point, absorb light only at relatively short wavelengths and have different mechanical, electrical and magnetic properties to macroscopic particles of the same material. By using nanoparticles as building blocks, it is possible to use many of these special properties also for macroscopic materials (Winnacker/Küchler, Chemische Technik: Prozesse and Produkte, (ed.: R. Dittmayer, W. Keim, G. Kreysa, A. Oberholz), Vol. 2: Neue Technologien, Chapter 9, Wiley-VCH Verlag 2004).

Within the scope of the present invention, the term “nanoparticles” refers to particles with an average diameter of from 1 to 500 nm, determined by means of electron microscopic methods.

Nanoparticulate zinc oxide with particle sizes below about 100 nm is potentially suitable for use as UV absorber in cosmetic sunscreen preparations or transparent organic-inorganic hybrid materials, plastics, paints and coatings. In addition, a use to protect UV-sensitive organic pigments and as antimicrobial active ingredient is also possible.

Particles, particle aggregates or agglomerates of zinc oxide which are larger than about 100 nm lead to scattered-light effects and thus to an undesired decrease in transparency in the visible light region. In any case, the highest possible transparency in the visible wavelength region and the highest possible absorption in the region of near ultraviolet light (UV-A region, about 320 to 400 nm wavelength) is desirable.

Nanoparticulate zinc oxide with particle sizes below about 5 nm exhibit, on account of the size quantization effect, a blue shift in the absorption edge (L. Brus, J. Phys. Chem. (1986), 90, 2555-2560) and are therefore less suitable for use as UV absorbers in the UV-A region.

The production of finely divided metal oxides, for example zinc oxide, by dry and wet processes is known. The classical method of burning zinc, which is known as the dry process (e.g. Gmelin Volume 32, 8th Edition, supplementary volume, p. 772ff), produces aggregated particles having a broad size distribution. Although in principle it is possible to produce particle sizes in the submicrometer range by grinding procedures, because the shear forces which can be achieved are too low, dispersions with average particle sizes in the lower nanometer range are obtainable from such powders only with very great expenditure. Particularly finely divided zinc oxide is produced primarily by wet chemical methods by precipitation processes. Precipitation in aqueous solution generally gives hydroxide- and/or carbonate-containing materials which have to be thermally converted to zinc oxide. The thermal aftertreatment here has an adverse effect on the finely divided nature since the particles are subjected during this treatment to sinter processes which lead to the formation of micrometer-sized aggregates which can be broken down only incompletely again to the primary particles by grinding.

Nanoparticulate metal oxides can, for example, be obtained by the microemulsion process. In this process, a solution of a metal alkoxide is added dropwise to a water-in-oil microemulsion. In the inverse micelles of the microemulsion, the size of which is in the nanometer range, then takes place the hydrolysis of the alkoxides to the nanoparticulate metal oxide. The disadvantages of this process are particularly that the metal alkoxides are expensive starting materials, that additionally emulsifiers have to be used and that the production of the emulsions with droplet sizes in the nanometer range is a complex process step.

DE 199 07 704 describes a nanoparticulate zinc oxide produced by a precipitation reaction. In the process, the nanoparticulate zinc oxide is produced starting from a zinc acetate solution via an alkaline precipitation. The centrifuged-off zinc oxide can be redispersed to a sol by adding methylene chloride. The zinc oxide dispersions produced in this way have the disadvantage that, because of the lack of surface modification, they do not have good long-term stability.

WO 00/50503 describes zinc oxide gels which comprise nanoparticulate zinc oxide with a particle diameter of ≦15 nm and which are redispersible to sols. Here, the solids produced by basic hydrolysis of a zinc compound in alcohol or in an alcohol/water mixture are redispersed by adding dichloromethane or chloroform. The disadvantage here is that stable dispersions are not obtained in water or in aqueous dispersants.

In the publication from Chem. Mater. 2000, 12, 2268-74 “Synthesis and Characterization of Poly(vinylpyrrolidone)-Modified Zinc Oxide Nanoparticles” by Lin Guo and Shihe Yang, zinc oxide nanoparticles are surface-coated with polyvinylpyrrolidone. The disadvantage here is that zinc oxide particles coated with polyvinylpyrrolidone are not dispersible in water.

WO 93/21127 describes a method of producing surface-modified nanoparticulate ceramic powders. Here, a nanoparticulate ceramic powder is surface-modified by applying a low molecular weight organic compound, for example propionic acid. This method cannot be used for the surface modification of zinc oxide since the modification reactions are carried out in aqueous solution and zinc oxide dissolves in aqueous organic acids. For this reason, this method cannot be used for producing zinc oxide dispersions; moreover, zinc oxide is not mentioned in this application either as a possible starting material for nanoparticulate ceramic powders,

WO 02/42201 describes a method of producing nanoparticulate metal oxides in which dissolved metal salts are thermally decomposed in the presence of surfactants. The decomposition takes place under conditions under which the surfactants form micelles; furthermore, depending on the metal salt chosen, temperatures of several hundred degrees Celsius may be required in order to achieve the decomposition. The method is therefore very costly in terms of apparatus and energy.

In the publication in Inorganic Chemistry 42(24), 2003, pp. 8105 to 8109, Z. Li et al. disclose a method of producing nanoparticulate zinc oxide rods by hydrothermal treatment of [Zn(OH)₄]²⁻ complexes in an autoclave in the presence of polyethylene glycol. However, autoclave technology is very complex and the rod-shaped habit of the products makes them unsuitable for applications on the skin.

WO 2004/052327 describes surface-modified nanoparticulate zinc oxides in which the surface modification comprises a coating with an organic acid. DE-A 10 2004 020 766 discloses surface-modified nanoparticulate metal oxides which have been produced in the presence of polyaspartic acid. EP 1455737 describes surface-modified nanoparticulate zinc oxides in which the surface modification comprises a coating with an oligo- or polyethylene glycolic acid. Some of these products are very costly to produce and are only partly suitable for cosmetic applications since they possibly have only poor skin compatability.

WO 98/13016 describes the use of surface-treated zinc oxide in cosmetic sunscreen preparations, with a surface treatment with polyacrylates also being disclosed. Details of the production of a zinc oxide treated with polyacrylates are not given.

The object of the present invention was therefore to provide methods of producing surface-modified nanoparticulate particles at least of one metal oxide, metal hydroxide and/or metal oxide hydroxide, and aqueous suspensions thereof, which have the highest possible transparency in the visible wavelength region and the highest possible absorption in the region of near ultraviolet light (UV-A region, about 320 to 400 nm wavelength) and, with regard to cosmetic applications, particularly in the field of UV protection, the substances used for the surface modification are characterized by good skin compatibility. A further object of the invention was to provide aqueous suspensions of surface-modified nanoparticulate particles at least of one metal oxide, metal hydroxide and/or metal oxide hydroxide, and the development of methods for their use.

This object is achieved by surface-modified nanoparticulate particles at least of one metal oxide, metal hydroxide and/or metal oxide hydroxide which are precipitated from a solution in the presence of a polyacrylate.

The invention thus provides a method of producing surface-modified nanoparticulate particles at least of one metal oxide, metal hydroxide and/or metal oxide hydroxide, where the metal or the metals are selected from the group consisting of aluminum, magnesium, cerium, iron, manganese, cobalt, nickel, copper, titanium, zinc and zirconium, comprising the steps

a) producing a solution of water and at least one metal salt of the abovementioned metals (solution 1) and a solution of water and at least one strong base (solution 2), where at least one of the two solutions 1 and 2 comprises at least one polyacrylate,

b) mixing the solutions 1 and 2 produced in step a) at a temperature in the range from 0 to 120° C., during which the surface-modified nanoparticulate particles are formed and precipitate out of the solution to form an aqueous suspension,

c) separating off the surface-modified nanoparticulate particles from the aqueous suspension obtained in step b), and

d) drying the surface-modified nanoparticulate particles obtained in step c).

The metal oxide, metal hydroxide and metal oxide hydroxide here may either be the anhydrous compounds or the corresponding hydrates.

The metal salts in process step a) may be metal halides, acetates, sulfates or nitrates. Preferred metal salts are halides, for example zinc chloride or titanium tetrachloride, acetates, for example zinc acetate, and nitrates, for example zinc nitrate. A particularly preferred metal salt is zinc chloride or zinc nitrate.

The concentration of the metal salts in solution 1 is generally in the range from 0.05 to 1 mol/l, preferably in the range from 0.1 to 0.5 mol/l, particularly preferably 0.2 to 0.4 mol/l.

The strong bases to be used according to the invention may in general be any substances which are able to produce a pH of from about 8 to about 13, preferably of from about 9 to about 12.5, in aqueous solution depending on their concentration. These may, for example, be metal oxides or hydroxides, and ammonia or amines. Preference is given to using alkali metal hydroxides, such as sodium or potassium hydroxide, alkaline earth metal hydroxides, such as calcium hydroxide or ammonia. Particular preference is given to using sodium hydroxide, potassium hydroxide and ammonia. In a preferred embodiment of the invention, ammonia can also be formed in situ during process steps a) and/or b) as a result of the thermal decomposition of urea.

The concentration of the strong base in solution 2 produced in process step a) is generally chosen so that a hydroxyl ion concentration in the range from 0.1 to 2 mol/l, preferably from 0.2 to 1 mol/l and particularly preferably from 0.4 to 0.8 mol/l is established in solution 2. Preferably, the hydroxyl ion concentration in solution 2 (c(OH⁻)) is chosen depending on the concentration and the valence of the metal ions in solution 1 (c(Mⁿ⁺)), so that it obeys the formula

n·c(Mⁿ⁺)=c(OH⁻)

where c is a concentration and Mⁿ⁺ is at least one metal ion with the valence n. For example, in the case of a solution 1 with a concentration of divalent metal ions of 0.2 mol/l, preference is given to using a solution 2 with a hydroxyl ion concentration of 0.4 mol/l.

According to the invention, the polyacrylates are polymers based on at least one α,β-unsaturated carboxylic acid, for example acrylic acid, methacrylic acid, dimethacrylic acid, ethacrylic acid, maleic acid, citraconic acid, methylenemalonic acid, crotonic acid, isocrotonic acid, fumaric acid, mesaconic acid and itaconic acid. Preferably, polyacrylates based on acrylic acid, methacrylic acid, maleic acid or mixtures thereof are used.

The fraction of the at least one aft-unsaturated carboxylic acid in the polyacrylates is generally between 20 and 100 mol %, preferably between 50 and 100 mol %, particularly preferably between 75 and 100 mol %.

The polyacrylates to be used according to the invention can be used either in the form of the free acid or else partially or completely neutralized in the form of their alkali metal, alkaline earth metal or ammonium salts. However, they can also be used as salts from the respective polyacrylic acid and triethylamine, ethanolamine, diethanolamine, triethanolamine, morpholine, diethylenetriamine or tetraethylenepentamine.

Besides the at least one α,β-unsaturated carboxylic acid, the polyacrylates can also comprise further comonomers which are copolymerized into the polymer chain, for example the esters, amides and nitriles of the carboxylic acids stated above, e.g. methyl acrylate, ethyl acrylate, methyl methacrylate, ethyl methacrylate, hydroethyl acrylate, hydroxypropyl acrylate, hydroxybutyl acrylate, hydroxyethyl methacrylate, hydroxypropyl methacrylate, hydroxyisobutyl acrylate, hydroxyisobutyl methacrylate, monomethyl maleate, dimethyl maleate, monoethyl maleate, diethyl maleate, 2-ethylhexyl acrylate, 2-ethylhexyl methacrylate, acrylamide, methacrylamide, N-dimethylacrylamide, N-tert-butylacrylamide, acrylonitrile, methacrylonitrile, dimethylaminoethyl acrylate, diethylaminoethyl acrylate, diethylaminoethyl methacrylate, and the salts of the last-mentioned basic monomers with carboxylic acids or mineral acids, and the quaternized products of the basic (meth)acrylates.

In addition, suitable further copolymerizable comonomers are allylacetic acid, vinylacetic acid, acrylamidoglycolic acid, vinylsulfonic acid, allylsulfonic acid, methallylsulfonic acid, styrenesulfonic acid, 3-sulfopropyl acrylate, 3-sulfopropyl methacrylate or acrylamidomethylpropanesulfonic acid, and monomers comprising phosphonic acid groups, such as vinyiphosphonic acid, allylphosphonic acid or acrylamidomethanepropanephosphonic acid. The monomers comprising acid groups can be used in the polymerization in the form of the free acid groups and in partially or completely neutralized form with bases.

Further suitable copolymerizable compounds are N-vinylcaprolactam, N-vinyl-imidazole, N-vinyl-2-methylimidazole, N-vinyl-4-methylimidazole, vinyl acetate, vinyl propionate, isobutene or styrene, and compounds with more than one polymerizable double bond, such as, for example, diallylammonium chloride, ethylene glycol dimethacrylate, diethylene glycol diacrylate, allyl methacrylate, trimethylolpropane triacrylate, triallylamine, tetraallyloxyethane, triallyl cyanurate, diallyl maleate, tetraallylethylenediamine, divinylideneurea, pentaerythritol di-, pentaerythritol tri- and pentaerythritol tetraallyl ethers, N,N′-methylenebisacrylamide or N,N′-methylene-bismethacrylamide.

It is of course also possible to use mixtures of said comonomers. For example, mixtures of 50 to 100 mol % of acrylic acid and 0 to 50 mol % of one or more of said comonomers are suitable for producing the polyacrylates according to the invention.

Many of the polyacrylates to be used according to the invention are commercially available under the tradename Sokalan® (BASF Aktiengesellschaft).

The concentration of the polyacrylates in the solutions 1 and/or 2 produced in process step a) is generally in the range from 0.1 to 20 g/l, preferably from 1 to 10 g/l, particularly preferably from 1.5 to 5 g/l. The polyacrylates to be used according to the invention must naturally have a corresponding solubility in water.

The molecular weight of the polyacrylates to be used according to the invention is generally in the range from 800 to 250 000 g/mol, preferably in the range from 1000 to 100 000 g/mol, particularly preferably in the range from 1000 to 20 000 g/mol.

A preferred embodiment of the method according to the invention is one in which the precipitation of the metal oxide, metal hydroxide and/or metal oxide hydroxide takes place in the presence of a polyacrylate which is obtained from pure acrylic acid. In a particularly preferred embodiment of the invention, Sokalan® PA 15 (BASF Aktiengesellschaft), the sodium salt of a polyacrylic acid, is used.

The mixing of the two solutions 1 and 2 (aqueous metal salt solution and aqueous base solution) in process step b) takes place at a temperature in the range from 0° C. to 120° C., preferably in the range from 10° C. to 100° C., particularly preferably in the range from 15° C. to 80° C.

Depending on the metal salts used, the mixing can be carried out at a pH in the range from 3 to 13. In the case of zinc oxide, the pH during mixing is in the range from 8 to 13.

According to the invention, the time for the mixing of the two solutions in process step b) is in the range from 1 second to 6 hours, preferably in the range from 1 minute to 2 hours. In general, the mixing time in the case of the discontinuous procedure is longer than in the case of the continuous procedure.

The mixing in process step b) can take place, for example, by combining an aqueous solution of a metal salt, for example of zinc chloride or zinc nitrate, with an aqueous solution of a mixture of a polyacrylate and an alkali metal hydroxide or ammonium hydroxide, in particular sodium hydroxide. Alternatively, it is also possible to combine an aqueous solution of a mixture of a polyacrylate and a metal salt, for example of zinc chloride or zinc nitrate, with an aqueous solution of an alkali metal hydroxide or ammonium hydroxide, in particular of sodium hydroxide. Furthermore, an aqueous solution of a mixture of a polyacrylate and a metal salt, for example of zinc chloride or zinc nitrate, can also be combined with an aqueous solution of a mixture of a polyacrylate and an alkali metal hydroxide or ammonium hydroxide, in particular sodium hydroxide.

In a preferred embodiment of the invention, the mixing in process step b) takes place through metered addition of an aqueous solution of a mixture of a polyacrylate and an alkali metal hydroxide or ammonium hydroxide, in particular sodium hydroxide, to an aqueous solution of a metal salt, for example of zinc chloride or zinc nitrate, or through metered addition of an aqueous solution of an alkali metal hydroxide or ammonium hydroxide, in particular sodium hydroxide, to an aqueous solution of a mixture of a polyacrylate and a metal salt, for example of zinc chloride or zinc nitrate.

During mixing and/or after mixing, the surface-modified nanoparticulate particles are formed and precipitate out of the solution to form an aqueous suspension. Preferably, the mixing takes place with simultaneous stirring of the mixture. After completely combining the two solutions 1 and 2, the stirring is preferably continued for a time between 30 minutes and 5 hours at a temperature in the range from 0° C. to 120° C.

A further preferred embodiment of the method according to the invention is one where at least one of process steps a) to d) is carried out continuously. In the case of a continuously operated procedure, process step b) is preferably carried out in a tubular reactor.

Preferably, the continuous method is carried out such that the mixing in process step b) takes place in a first reaction space at a temperature T1, in which an aqueous solution 1 at least of one metal salt and an aqueous solution 2 at least of one strong base are continuously introduced, where at least one of the two solutions 1 and 2 comprises at least one a polyacrylate from which the formed suspension is continuously removed and transferred to a second reaction space for heating at a temperature T2, during which the surface-modified nanoparticulate particles are formed.

As a rule, the continuous process is carried out such that the temperature T2 is higher than the temperature T1.

The methods described at the outset are particularly suitable for producing surface-modified nanoparticulate particles of titanium dioxide and zinc oxide, in particular of zinc oxide. In this case, the precipitation of the surface-modified nanoparticulate particles of zinc oxide takes place from an aqueous solution of zinc acetate, zinc chloride or zinc nitrate at a pH in the range from 8 to 13 in the presence of at least one polyacrylate.

An advantageous embodiment of the method according to the invention is one in which the surface-modified nanoparticulate particles of a metal oxide, metal hydroxide and/or metal oxide hydroxide, in particular of zinc oxide, have a high light transmittance in the region of visible light and a low light transmittance in the region of near ultraviolet light (UV-A). Preferably, the ratio of the logarithm of the percentage transmission (T) at a wavelength of 360 nm and the logarithm of the percentage transmission at a wavelength of 450 nm [In T(360 nm)/In T(450 nm)] is at least 15, particularly preferably at least 18. This ratio is usually measured on a 5 to 10% strength by weight oil dispersion of the nanoparticulate particles (cf. U.S. Pat. No. 6,171,580).

A further advantageous embodiment of the method according to the invention is one in which the surface-modified nanoparticulate particles of a metal oxide, metal hydroxide and/or metal oxide hydroxide, in particular of zinc oxide, have a BET surface area in the range from 25 to 500 m²/g, preferably 30 to 400 m²/g, particularly preferably 40 to 300 m²/g.

The invention is based on the finding that a surface modification of nanoparticulate metal oxides, metal hydroxides and/or metal oxide hydroxides with polyacrylates can achieve long-term stability of dispersions of the surface-modified nanoparticulate metal oxides, in particular in cosmetic preparations, without undesired changes in the pH during storage of these preparations.

The precipitated particles can be separated off from the aqueous suspension in process step c) in a manner known per se, for example by filtration or centrifugation. If required, the aqueous dispersion can be concentrated prior to isolating the precipitated particles by means of a membrane method, such as nano-, ultra-, micro- or crossflow filtration and, if appropriate, be at least partially freed from undesired water-soluble constituents, for example alkali metal salts, such as sodium chloride or sodium nitrate.

It has proven to be advantageous to carry out the separation of the surface-modified nanoparticulate particles from the aqueous suspension obtained in step b) at a temperature in the range from 10 to 50° C., preferably at room temperature. It is therefore advantageous to cool, if appropriate, the aqueous suspension obtained in step b) to such a temperature.

In process step d), the filter cake obtained can be dried in a manner known per se, for example in a drying cabinet at temperatures between 40 and 100° C., preferably between 50 and 80° C., under atmospheric pressure to a constant weight.

The present invention further provides surface-modified nanoparticulate particles at least of one metal oxide, metal hydroxide and/or metal oxide hydroxide, where the metal or the metals are selected from the group consisting of aluminum, magnesium, cerium, iron, manganese, cobalt, nickel, copper, titanium, zinc and zirconium, and the surface modification comprises a coating with at least one polyacrylate with a BET surface area in the range from 25 to 500 m²/g, preferably 30 to 400 m²/g, particularly preferably 40 to 300 m²/g, which are obtainable by the method described above.

According to a preferred embodiment of the present invention, the surface-modified nanoparticulate particles have a diameter of from 10 to 200 nm. This is particularly advantageous since good redispersibility is ensured within this size distribution.

According to a particularly preferred embodiment of the present invention, the surface-modified nanoparticulate particles have a diameter of from 20 to 100 nm. This size range is particularly advantageous since, for example following redispersion of such zinc oxide nanoparticles, the resulting suspensions are transparent and thus do not affect the coloring when added to cosmetic formulations. Moreover, this also gives rise to the possibility of use in transparent films.

The nanoparticulate particles according to the invention are notable for a high light transmittance in the region of visible light and for a low light transmittance in the region of near ultraviolet light (UV-A). Preferably, the ratio of the logarithm of the percentage transmission (T) at a wavelength of 360 nm and the logarithm of the percentage transmission at a wavelength of 450 nm [In T(360 nm)/In T(450 nm)] is at least 15, particularly preferably at least 18.

The present invention further provides the use of surface-modified nanoparticulate particles at least of one metal oxide, metal hydroxide and/or metal oxide hydroxide, in particular titanium dioxide or zinc oxide, which are produced by the method according to the invention as UV protectants in cosmetic sunscreen preparations, as stabilizer in plastics and as antimicrobial active ingredient.

According to a preferred embodiment of the present invention, the surface-modified nanoparticulate particles at least of one metal oxide, metal hydroxide and/or metal oxide hydroxide, in particular titanium dioxide or zinc oxide, are redispersible in a liquid medium and form stable suspensions. This is particularly advantageous because, for example, the suspensions produced from the zinc oxide according to the invention do not have to be dispersed again prior to further processing, but can be processed directly.

According to a preferred embodiment of the present invention, the surface-modified nanoparticulate particles at least of one metal oxide, metal hydroxide and/or metal oxide hydroxide are redispersible in polar organic solvents and form stable suspensions. This is particularly advantageous since, as a result of this, uniform incorporation, for example into plastics or films, is possible.

According to a further preferred embodiment of the present invention, the surface-modified nanoparticulate particles at least of one metal oxide, metal hydroxide and/or metal oxide hydroxide are redispersible in water, where they form stable suspensions. This is particularly advantageous since this opens up the possibility of using the material according to the invention for example in cosmetic formulations, where dispensing with organic solvents is a great advantage. Mixtures of water and polar organic solvents are also conceivable.

Since numerous applications of the surface-modified nanoparticulate particles according to the invention at least of one metal oxide, metal hydroxide and/or metal oxide hydroxide require them to be used in the form of an aqueous suspension, it is possible, if appropriate, to dispense with their isolation as solid,

The present invention therefore further provides a method of producing an aqueous suspension of surface-modified nanoparticulate particles at least of one metal oxide, metal hydroxide and/or metal oxide hydroxide, where the metal or the metals are chosen from the group consisting of aluminum, magnesium, cerium, iron, manganese, cobalt, nickel, copper, titanium, zinc and zirconium, comprising the steps

a) producing a solution of water and at least one metal salt of the abovementioned metals (solution 1) and a solution of water and at least one strong base (solution 2), where at least one of the two solutions 1 and 2 comprises at least one polyacrylate,

b) mixing the solutions 1 and 2 produced in step a) at a temperature in the range from 0 to 120° C., during which the surface-modified nanoparticulate particles are formed and precipitate out of the solution to form an aqueous suspension,

c) if appropriate concentrating the formed aqueous suspension and/or separating off by-products.

For a more detailed description of the procedure for process steps a) and b), of the feed substances and process parameters used, and of the product properties, reference is made to the statements made above.

if required, the aqueous suspension formed in step b) can be concentrated in process step c), for example if a higher solids content is desired. Concentration can be carried out in a manner known per se, for example by distilling off the water (at atmospheric pressure or at reduced pressure), filtration or centrifugation.

In addition, it may be required to separate off by-products from the aqueous suspension formed in step b) in process step c), namely when these would interfere with the further use of the suspension. By-products coming into consideration are primarily salts dissolved in water which are formed during the reaction according to the invention between the metal salt and the strong base besides the desired metal oxide, metal hydroxide and/or metal oxide hydroxide particles, for example sodium chloride, sodium nitrate or ammonium chloride. Such by-products can be largely removed from the aqueous suspension for example by means of a membrane method, such as nano-, ultra-, micro- or crossflow filtration.

A further preferred embodiment of the method according to the invention is one in which at least one of the process steps a) to c) is carried out continuously.

The present invention further provides aqueous suspensions of surface-modified nanoparticulate particles at least of one metal oxide, metal hydroxide and/or metal oxide hydroxide, where the metal or the metals are chosen from the group consisting of aluminum, magnesium, cerium, iron, manganese, cobalt, nickel, copper, titanium, zinc and zirconium, and the surface modification comprises a coating with at least one polyacrylate, obtainable by the method described above.

According to a preferred embodiment of the invention, the surface-modified nanoparticulate particles in the aqueous suspensions are coated with a polyacrylate which is a polyacrylic acid.

The present invention further provides the use of aqueous suspensions of surface-modified nanoparticulate particles at least of one metal oxide, metal hydroxide and/or metal oxide hydroxide, in particular titanium dioxide or zinc oxide, which are produced by the method according to the invention as UV protectants in cosmetic sunscreen preparations, as stabilizer in plastics and as antimicrobial active ingredient.

By reference to the examples below, the aim is to illustrate the invention in more detail.

### Example 1

Discontinuous preparation of nanoparticulate zinc oxide in the presence of Sokalan® PA 15 (sodium polyacrylate)

Firstly, two aqueous solutions 1 and 2 were prepared. Solution 1 comprised 54.52 g of zinc chloride per liter and had a zinc ion concentration of 0.4 mol/l.

Solution 2 comprised 32 g of sodium hydroxide per liter and thus had a hydroxyl ion concentration of 0.8 mol/l. Moreover, solution 2 also comprised 4 g/l of Sokalan® PA 15.

1000 ml of solution 1 and 1000 ml of solution 2 were heated to 40° C. and mixed with stirring over the course of 6 minutes. During this time, a white suspension formed. The precipitated, surface-modified product was filtered off and washed with water, and the filter cake was dried at 80° C. in a drying cabinet. The resulting powder had the absorption band at about 350-360 nm characteristic of zinc oxide in the UV-VIS spectrum.

### Example 2

Continuous preparation of nanoparticulate zinc oxide in the presence of Sokalan® PA 15

5 l of water at a temperature of 25° C. were added to a glass reactor with a total volume of 8 l and this was stirred with a rotational speed of 250 rpm. With further stirring, solutions 1 and 2 from example 1 were continuously metered into the initial charge of water using two HPLC pumps (Knauer, model K 1800, pump head 500 ml/min) via two separate feed tubes, in each case at a metering rate of 0.48 l/min. During this, a white suspension formed in the glass reactor. At the same time, a suspension stream of 0.96 l/min was pumped out of the glass reactor via a riser tube by means of a gear pump (Gather Industrie GmbH, D-40822 Mettmann) and heated to a temperature of 85° C. in a downstream heat exchanger over the course of 1 minute. The resulting suspension then flowed through a second heat exchanger, where the suspension was kept at 85° C. for a further 30 seconds. The suspension then flowed successively through a third and fourth heat exchanger, where the suspension was cooled to room temperature over the course of a further minute.

The freshly produced suspension was thickened by a factor of 15 in a crossflow ultrafiltration laboratory installation (Sartorius, model SF Alpha, PES cassette, cut off 100 kD). Subsequent isolation of the solid powder was carried out using an ultracentrifuge (Sigma 3K30, 20 000 rpm, 40 700 g) with subsequent drying at 50° C.

The resulting powder had, in the UV-VIS spectrum, the absorption band at about 350-360 nm characteristic of zinc oxide. In agreement with this, the X-ray diffraction of the powder showed exclusively the diffraction reflections of hexagonal zinc oxide. The half-width of the X-ray reflections was used to calculate a crystallite size, which is between 16 nm [for the (102) reflection] and 57 nm [for the (002) reflection]. In transmission electron microscopy (TEM), the resulting powder had an average particle size of about 50.

### Example 3

Continuous preparation of nanoparticulate zinc oxide in the presence of Sokalan® PA 18 PN

Firstly, two aqueous solutions 1 and 2 were prepared. Solution 1 comprised 54.52 g of zinc chloride per liter and had a zinc ion concentration of 0.4 mol/l.

Solution 2 comprised 32 g of sodium hydroxide per liter and thus had a hydroxyl ion concentration of 0.8 mol/l. Moreover, solution 2 also comprised 4 g/l of Sokalan® PA 18 PN.

5 l of water at a temperature of 25° C. were added to a glass reactor with a total volume of 8 l and this was stirred with a rotational speed of 250 rpm. With further stirring, solutions 1 and 2 were continuously metered into the initial charge of water using two HPLC pumps (Knauer, model K 1800, pump head 500 ml/min) via two separate feed tubes, in each case at a metering rate of 0.48 l/min. During this, a white suspension formed in the glass reactor. At the same time, a suspension stream of 0.96 l/min was pumped out of the glass reactor via a riser tube by means of a gear pump (Gather Industrie GmbH, D-40822 Mettmann) and heated to a temperature of 85° C. in a downstream heat exchanger over the course of 1 minute. The resulting suspension then flowed through a second heat exchanger, where the suspension was kept at 85° C. for a further 30 seconds. The suspension then flowed successively through a third and fourth heat exchanger, where the suspension was cooled to room temperature over the course of a further minute.

The freshly produced suspension was thickened by a factor of 15 in a crossflow ultrafiltration laboratory installation (Sartorius, model SF Alpha, PES cassette, cut off 100 kD). Subsequent isolation of the solid powder was carried out using an ultracentrifuge (Sigma 3K30, 20 000 rpm, 40 700 g) with subsequent drying at 50° C.

The resulting powder had, in the UV-VIS spectrum, the absorption band at about 350-360 nm characteristic of zinc oxide. In agreement with this, the X-ray diffraction of the powder showed exclusively the diffraction reflections of hexagonal zinc oxide. In transmission electron microscopy (TEM), the resulting powder had an average particle size of about 50 nm.

### Example 4

Continuous preparation of nanoparticulate zinc oxide in the presence of Sokalan® PA 20

Firstly, two aqueous solutions 1 and 2 were prepared. Solution 1 comprised 54.52 g of zinc chloride per liter and had a zinc ion concentration of 0.4 mol/l.

Solution 2 comprised 32 g of sodium hydroxide per liter and thus had a hydroxyl ion concentration of 0.8 mol/l. Moreover, solution 2 also comprised 4 g/l of Sokalan® PA 20.

5 l of water at a temperature of 25° C. were added to a glass reactor with a total volume of 8 l and this was stirred with a rotational speed of 250 rpm. With further stirring, solutions 1 and 2 were continuously metered into the initial charge of water using two HPLC pumps (Knauer, model K 1800, pump head 500 ml/min) via two separate feed tubes, in each case at a metering rate of 0.48 l/min. During this, a white suspension formed in the glass reactor. At the same time, a suspension stream of 0.96 l/min was pumped out of the glass reactor via a riser tube by means of a gear pump (Gather Industrie GmbH, D-40822 Mettmann) and heated to a temperature of 85° C. in a downstream heat exchanger over the course of 1 minute. The resulting suspension then flowed through a second heat exchanger, where the suspension was kept at 85° C. for a further 30 seconds. The suspension then flowed successively through a third and fourth heat exchanger, where the suspension was cooled to room temperature over the course of a further minute.

The freshly produced suspension was thickened by a factor of 15 in a crossflow ultrafiltration laboratory installation (Sartorius, model SF Alpha, PES cassette, cut off 100 kD). Subsequent isolation of the solid powder was carried out using an ultracentrifuge (Sigma 3K30, 20 000 rpm, 40 700 g) with subsequent drying at 50° C.

The resulting powder had, in the UV-VIS spectrum, the absorption band at about 350-360 nm characteristic of zinc oxide. in agreement with this, the X-ray diffraction of the powder showed exclusively the diffraction reflections of hexagonal zinc oxide. In transmission electron microscopy (TEM), the resulting powder had an average particle size of about 70 nm.

### Example 5

Continuous preparation of nanoparticulate zinc oxide in the presence of Sokalan® PA 30 PN

Firstly, two aqueous solutions 1 and 2 were prepared. Solution 1 comprised 54.52 g of zinc chloride per liter and had a zinc ion concentration of 0.4 mol/l.

Solution 2 comprised 32 g of sodium hydroxide per liter and thus had a hydroxyl ion concentration of 0.8 mol/l. Moreover, solution 2 also comprised 4 g/l of Sokalan® PA 30 PN.

5 l of water at a temperature of 25° C. were added to a glass reactor with a total volume of 8 l and this was stirred with a rotational speed of 250 rpm. With further stirring, solutions 1 and 2 were continuously metered into the initial charge of water using two HPLC pumps (Knauer, model K 1800, pump head 500 ml/min) via two separate feed tubes, in each case at a metering rate of 0.48 l/min. During this, a white suspension formed in the glass reactor. At the same time, a suspension stream of 0.96 l/min was pumped out of the glass reactor via a riser tube by means of a gear pump (Gather Industrie GmbH, D-40822 Mettmann) and heated to a temperature of 85° C. in a downstream heat exchanger over the course of 1 minute. The resulting suspension then flowed through a second heat exchanger, where the suspension was kept at 85° C. for a further 30 seconds. The suspension then flowed successively through a third and fourth heat exchanger, where the suspension was cooled to room temperature over the course of a further minute.

The freshly produced suspension was thickened by a factor of 15 in a crossflow ultrafiltration laboratory installation (Sartorius, model SF Alpha, PES cassette, cut off 100 kD). Subsequent isolation of the solid powder was carried out using an ultracentrifuge (Sigma 3K30, 20 000 rpm, 40 700 g) with subsequent drying at 50° C.

The resulting powder had, in the UV-VIS spectrum, the absorption band at about 350-360 nm characteristic of zinc oxide. In agreement with this, the X-ray diffraction of the powder showed exclusively the diffraction reflections of hexagonal zinc oxide. In transmission electron microscopy (TEM), the resulting powder had an average particle size of about 80 nm.

### Example 6

Continuous preparation of nanoparticulate zinc oxide in the presence of Sokalan® PA 30 PN

Firstly, two aqueous solutions 1 and 2 were prepared. Solution 1 comprised 27.26 g of zinc chloride per liter and had a zinc ion concentration of 0.2 mol/l.

Solution 2 comprised 16 g of sodium hydroxide per liter and thus had a hydroxyl ion concentration of 0.4 Moreover, solution 2 also comprised 4 g/l of Sokalan® PA 30 PN.

5 l of water at a temperature of 25° C. were added to a glass reactor with a total volume of 8 l and this was stirred with a rotational speed of 250 rpm. With further stirring, solutions 1 and 2 were continuously metered into the initial charge of water using two HPLC pumps (Knauer, model K 1800, pump head 500 ml/min) via two separate feed tubes, in each case at a metering rate of 0.48 l/min. During this, a white suspension formed in the glass reactor. At the same time, a suspension stream of 0.96 l/min was pumped out of the glass reactor via a riser tube by means of a gear pump (Gather Industrie GmbH, D-40822 Mettmann) and heated to a temperature of 85° C. in a downstream heat exchanger over the course of 1 minute. The resulting suspension then flowed through a second heat exchanger, where the suspension was kept at 85° C. for a further 30 seconds. The suspension then flowed successively through a third and fourth heat exchanger, where the suspension was cooled to room temperature over the course of a further minute.

The freshly produced suspension was thickened by a factor of 15 in a crossflow ultrafiltration laboratory installation (Sartorius, model SF Alpha, PES cassette, cut off 100 kD). Subsequent isolation of the solid powder was carried out using an ultracentrifuge (Sigma 3K30, 20 000 rpm, 40 700 g) with subsequent drying at 50° C.

The resulting powder had, in the UV-VIS spectrum, the absorption band at about 350-360 nm characteristic of zinc oxide. In agreement with this, the X-ray diffraction of the powder showed exclusively the diffraction reflections of hexagonal zinc oxide. In transmission electron microscopy (TEM), the resulting powder had an average particle size of about 40 nm.

1.-21. (canceled)

22. A method of producing surface-modified nanoparticulate particles at least of one metal oxide, metal hydroxide and/or metal oxide hydroxide, where the metal or the metals are selected from the group consisting of aluminum, magnesium, cerium, iron, manganese, cobalt, nickel, copper, titanium, zinc and zirconium, comprising the steps
a) producing a solution of water and at least one metal salt of the abovementioned metals (solution 1) and a solution of water and at least one strong base (solution 2), where at least one of the two solutions 1 and 2 comprises at least one polyacrylate, where the polyacrylate
is a polymer based on at least one α,β-unsaturated carboxylic acid, where the fraction of the at least one α,β-unsaturated carboxylic acid in the polyacrylates is between 50 and 100 mol %, or
is a polymer which has been prepared from 100 mol % of acrylic acid,
b) mixing the solutions 1 and 2 produced in step a) at a temperature in the range from 0 to 120° C., during which the surface-modified nanoparticulate particles are formed and precipitate out of the solution to form an aqueous suspension,
c) separating off the surface-modified nanoparticulate particles from the aqueous suspension obtained in step b), and
d) drying the surface-modified nanoparticulate particles obtained in step c).

23. The method according to claim 22, wherein the metal salt is zinc chloride, zinc nitrate, zinc acetate or titanium tetrachloride.

24. The method according to claim 22, wherein the strong base is an alkali metal hydroxide, an alkaline earth metal hydroxide or ammonia.

25. The method according to claim 22, wherein the polyacrylate has a molecular weight in the range from 800 to 250 000 g/mol.

26. The method according to claim 22, wherein at least one of the process steps a) to d) is carried out continuously.

27. A surface-modified nanoparticulate particle comprising at least of one metal oxide, metal hydroxide and/or metal oxide hydroxide, wherein the metal or the metals are selected from the group consisting of aluminum, magnesium, cerium, iron, manganese, cobalt, nickel, copper, titanium, zinc and zirconium, and the surface modification comprises a coating with at least one polyacrylate with a BET surface area in the range from 25 to 500 m²/g, obtainable by the method according to claim 22.

28. The surface-modified nanoparticulate particle according to claim 27 with a diameter of from 10 to 200 nm.

29. A process to make an article which comprises utilizing the surface-modified nanoparticulate particles as claimed in claim 27, wherein the article is a UV protectant in cosmetic sunscreen preparations, a stabilizer in plastics or an antimicrobial active ingredient.

30. The process according to claim 29, wherein the particles comprise zinc oxide or titanium dioxide.

31. A method of producing an aqueous suspension of surface-modified nanoparticulate particles at least of one metal oxide, metal hydroxide and/or metal oxide hydroxide, where the metal or the metals are selected from the group consisting of aluminum, magnesium, cesium, iron, manganese, cobalt, nickel, copper, titanium, zinc and zirconium, comprising the steps
a) producing a solution of water and at least one metal salt of the abovementioned metals (solution 1) and a solution of water and at least one strong base (solution 2), wherein at least one of the two solutions 1 and 2 comprises at least one polyacrylate, where the polyacrylate
is a polymer based on at least one α,β-unsaturated carboxylic acid, where the fraction of the at least one α,β-unsaturated carboxylic acid in the polyacrylates is between 50 and 100 mol %, or
is a polymer which has been prepared from 100 mol % of acrylic acid,
b) mixing the solutions 1 and 2 produced in step a) at a temperature in the range from 0 to 120° C., during which the surface-modified nanoparticulate particles are formed and precipitate out of the solution to form an aqueous suspension, and
c) optionally concentrating the formed aqueous suspension and/or separating off by-products.

32. The method according to claim 31, wherein the metal salt is zinc chloride, zinc nitrate, zinc acetate or titanium tetrachloride.

33. The method according to claim 31, wherein the strong base is an alkali metal hydroxide, an alkaline earth metal hydroxide or ammonia.

34. The method according to claim 31, wherein the polyacrylate comprises between 50 and 100 mol % of at least one α,β-unsaturated carboxylic acid.

35. The method according to claim 31, wherein the polyacrylate has a molecular weight in the range from 800 to 250 000 g/mol.

36. The method according to claim 31, wherein at least one of the process steps a) to c) is carried out continuously.

37. An aqueous suspension of surface-modified nanoparticulate particles at least of one metal oxide, metal hydroxide and/or metal oxide hydroxide, where the metal or the metals are selected from the group consisting of aluminum, magnesium, cerium, iron, manganese, cobalt, nickel, copper, titanium, zinc and zirconium, and the surface modification comprises a coating with at least one polyacrylate, obtainable by a method according to claim 31.

38. An aqueous suspension according to claim 37, where the particles have a diameter of from 10 to 200 nm.

39. The aqueous suspension according claim 37, where the polyacrylate is a polyacrylic acid.

40. A process to make an article which comprises utilizing the surface-modified nanoparticulate particles as claimed in claim 37, wherein the article is a UV protectant in cosmetic sunscreen preparations, a stabilizer in plastics or an antimicrobial active ingredient.

41. The process according to claim 40, wherein the particles comprise zinc oxide or titanium dioxide.
